(19) United States
(12) Patent Application Publication
(10) Pub. No.: US 2013/0064077 A1
(43) Pub. Date: Mar. 14, 2013

(54) NODE APPARATUS, SYSTEM, AND PACKET PROCESSING METHOD

(71) Applicants: Yasusi KANADA, Tokyo (JP); Yasushi KASUGAI, Ninomiya (JP)

(72) Inventors: Yasusi KANADA, Tokyo (JP); Yasushi KASUGAI, Ninomiya (JP)

(73) Assignee: HITACHI, LTD., Tokyo (JP)

(21) Appl. No.: 13/588,412

(22) Filed: Aug. 17, 2012

(30) Foreign Application Priority Data
Sep. 13, 2011 (JP) 2011-199737

(51) Int. Cl. H04L 12/24

(52) U.S. Cl. 370/229

(57) ABSTRACT

A node apparatus capable of performing flexible load distribution and performing a high speed processing of packets, has an interface connecting to multiple packet processors through a switch, stores association information for associating each packet with information of the packet processor, and forwards a packet associated with information of a first packet processor in the association information to the first packet processor. The node apparatus has a control unit that when the first packet processor is determined to be in high load more than or equal to a threshold, updates the association information so that a packet being processable by the first packet processor may also be associated with information of a second packet processor in the association information. The interface forwards a packet associated with the information of the second packet processor in the updated association information to the second packet processor unit.

### CLAIM OF PRIORITY

The present application claims priority from Japanese patent application JP 2011-199737 filed on Sep. 13, 2011, the content of which is hereby incorporated by reference into this application.

### FIELD OF THE INVENTION

The present invention relates to a node apparatus, a system, and a packet processing method.

### BACKGROUND OF THE INVENTION

One problem about a packet stream processing and a data stream processing in a network is to provide multiple advanced services to multiple users, and further to cope with a variation of a load during an operation of the network.

Japanese Unexamined Patent Application Publication No. 2010-193366 discloses a method for providing multiple advanced services to multiple users without causing mutual interference by virtualizing a network node and making it programmable. However, in Japanese Unexamined Patent Application Publication No. 2010-193366, a processor is assigned fixedly for each service, and load distribution in which a load of one service is distributed to multiple processors is not described.

Japanese Unexamined Patent Application Publication No. 2004-135106 discloses the load distribution performed when the load of the network node increases. Here, when the load increases, a packet is processed in a processor unit in low load.

### SUMMARY OF THE INVENTION

In the case where the processor is assigned to each service as in a conventional technology of Japanese Unexamined Patent Application Publication No. 2010-193366, depending on a time, a deviation in load of each processor becomes large and it becomes impossible to use the processor efficiently. Moreover, when load forecast for every service is difficult, it becomes difficult to apply a technology of Japanese Unexamined Patent Application Publication No. 2004-135106. Furthermore, the technology of Japanese Unexamined Patent Application Publication No. 2004-135106 has a possibility that a high speed processing cannot be performed while performing load distribution.

An object of the present invention is to provide a node apparatus capable of distributing a load of a packet processing flexibly even in a situation where the load of the packet processing varies dynamically and is difficult to predict, and capable of high-speed processing of the packet.

A typical aspect of the present invention is as follows. That is, a node apparatus connecting to the network includes: multiple packet processor units; an interface unit that connects to the multiple packet processor units via a switch, stores association information for associating each packet with information of the packet processor unit capable of processing this, and forwards a packet that is associated with information of a first packet processor unit in the association information to the first packet processor unit; and a control unit of, when the first packet processor unit is determined to be in high load, updating the association information so that the packet being processable by the first packet processor unit may also be associated with information of a second packet processor unit in the association information; in which the interface unit forwards a packet that is associated with the information of the second packet processor unit in the updated association information to the second packet processor unit.

According to the aspect of the present invention, the node apparatus is enabled to perform flexible load distribution by dynamically increasing/decreasing the number of the packet processor units each for processing a packet. Moreover, since the interface unit has the association information for associating the packet with the information of the packet processor unit capable of processing this, packets can be distributed to the packet processor units at high speed, which makes possible a high speed processing of the packets.

### BRIEF DESCRIPTION OF THE DRAWINGS

FIG. 1 is a schematic diagram showing one example of a configuration of an entire network system;

FIG. 2 is a block diagram showing a configuration of a packet stream processor in an embodiment;

FIG. 3 is a block diagram showing a configuration of a packet processing board (PPB);

FIG. 4 is a block diagram showing a configuration of a network interface (NIF);

FIG. 5 is a block diagram showing a configuration of a network processing unit (NPU);

FIG. 6 is a flowchart showing a procedure of a program loading processing in a control board;

FIG. 7 is a flowchart showing a procedure of a program unloading processing in the control board;

FIG. 8 is a flowchart showing a procedure of a load monitoring processing in the control board;

FIG. 9 is a flowchart showing a procedure of a packet forwarding processing in the interface;

FIG. 10, is a figure showing one example of a packet processing board selecting processing in the interface;

FIG. 11A is a table illustrating correspondence of bits of a bit vector QAVAIL and PPB queues; and

FIG. 11B is a table illustrating the correspondence of the bits of the bit vector QAVAIL and the packet processing boards.

### DETAILED DESCRIPTION OF THE PREFERRED EMBODIMENTS

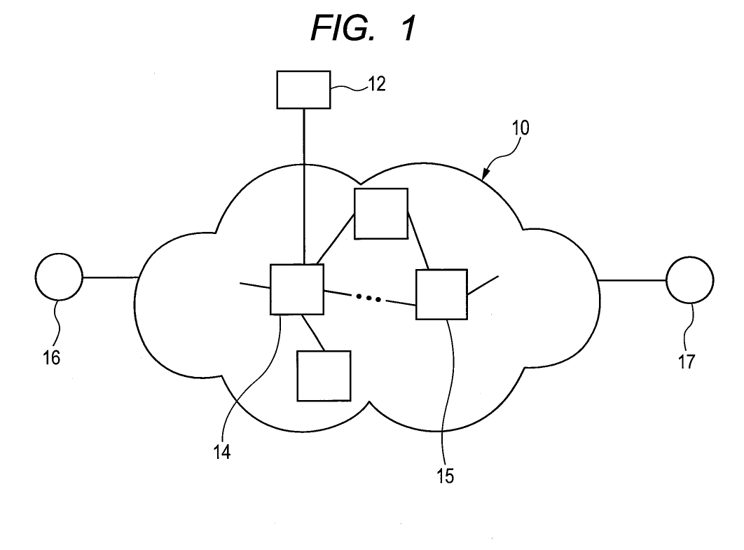

FIG. 1 schematically shows one example of a configuration of an entire network system. The network system has a network management device 12 (for example, a management computer (server)) for managing an entire network 10, multiple node apparatuses 14, 15 contained in the network, terminals 16, 17, etc.

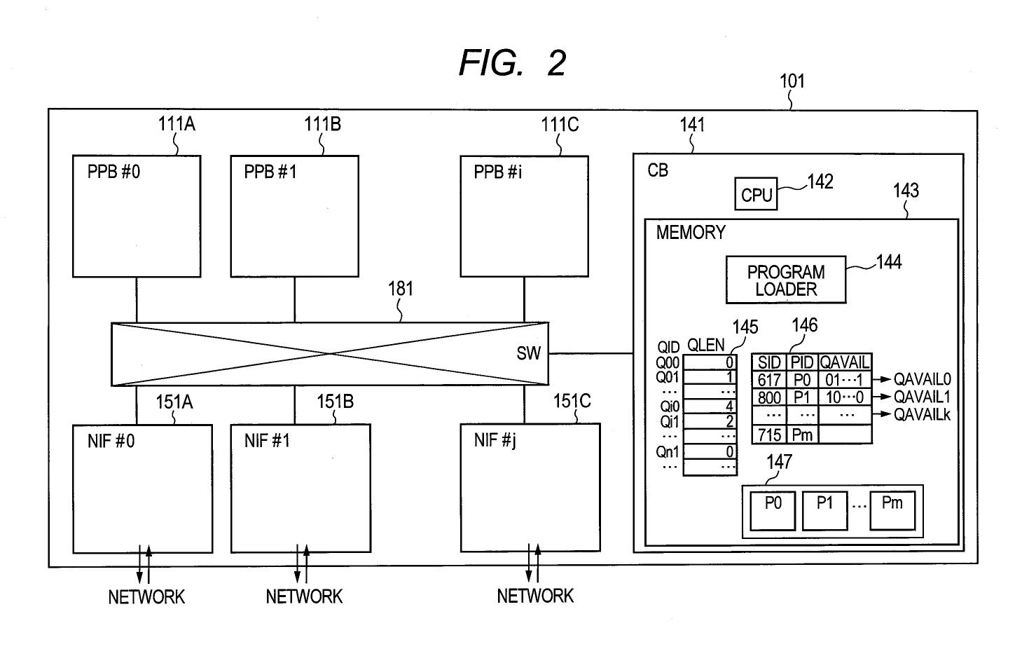

FIG. 2 shows an entire configuration of a packet stream processor 101 as one certain node apparatus. The packet stream processor 101 is comprised of multiple packet processing boards (PPBs) 111, at least one network interface (NIF) 151, a control board (CB) 141, and a switch fabric 181 (it is also called simply a switch) for connecting them. The packet processing board, the network interface, and the control board may be called, respectively, a packet processor unit, an interface unit (or an interface), and a control unit. The packet stream processor 101 is connected to the network with the interface 151. Incidentally, although a control board 141 is built in the packet stream processor 101 in this embodiment, it may exist in the interior of a server etc. outside the packet stream processor 101.

The packet stream processor 101 has N packet processing boards 111 and M interfaces 151. However, FIG. 2 shows only three of the N packet processing boards 111 as packet processing boards 111A, 111B, and 111C, and shows only three of the M interfaces 151 as interfaces 151A, 151B, and 151C. In this embodiment, when giving an explanation common to all the packet processing boards 111A, 111B, and 111C, these are also generically named the packet processing board 111. Similarly, when giving an explanation common to all the interfaces 151A, 151B, and 151C, these are also generically named the interface 151.

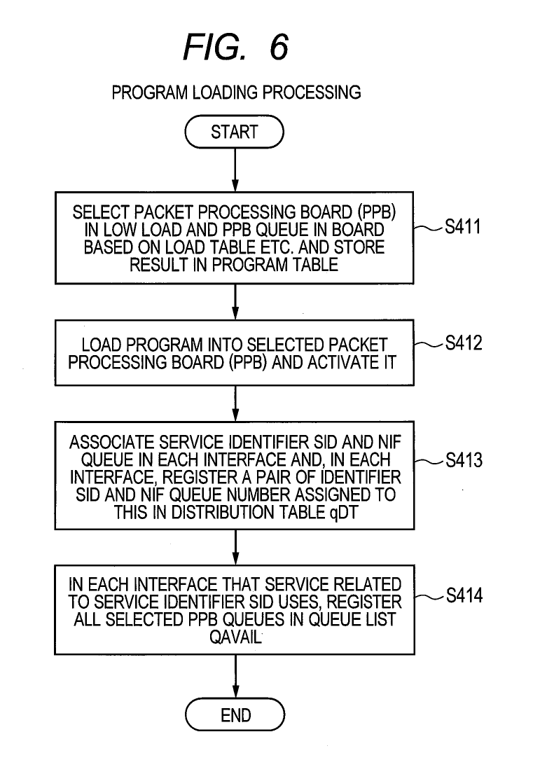

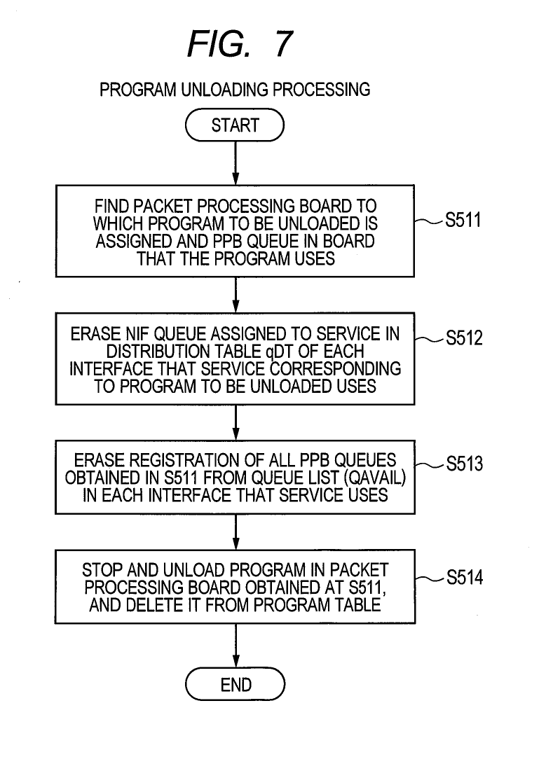

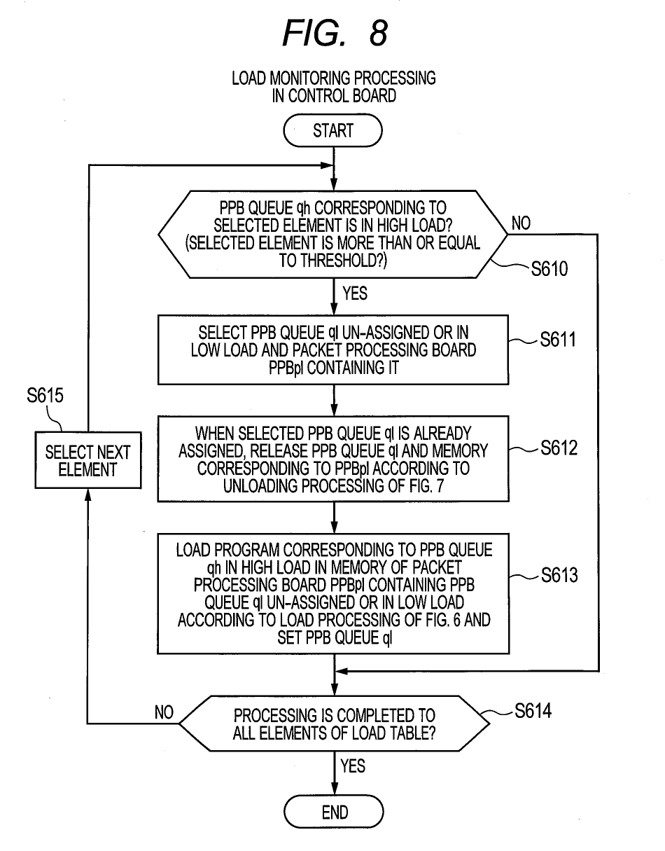

The control board 141 is a computer, which has a CPU (central processing unit) 142 and memory 143. The memory 143 includes a program loader 144 that is a program executed by the CPU 142, a load table 145, a program table 146, and a program storing unit (program store) 147. The program loader 144 loads programs P0, P1, . . . , Pm stored in the program storing unit 147 into memory (below-mentioned DRAM 113) of the packet processing board 111. The program loader 144 may load the programs P0, P1, . . . , Pm existing in URL (Uniform Resource Locator) stored in the program storing unit 147 into the memory (the DRAM 113) of the packet processing board 111. The processing that the program loader 144 performs using the CPU 142 will be explained in detail with reference to FIG. 6, FIG. 7, and FIG. 8 later.

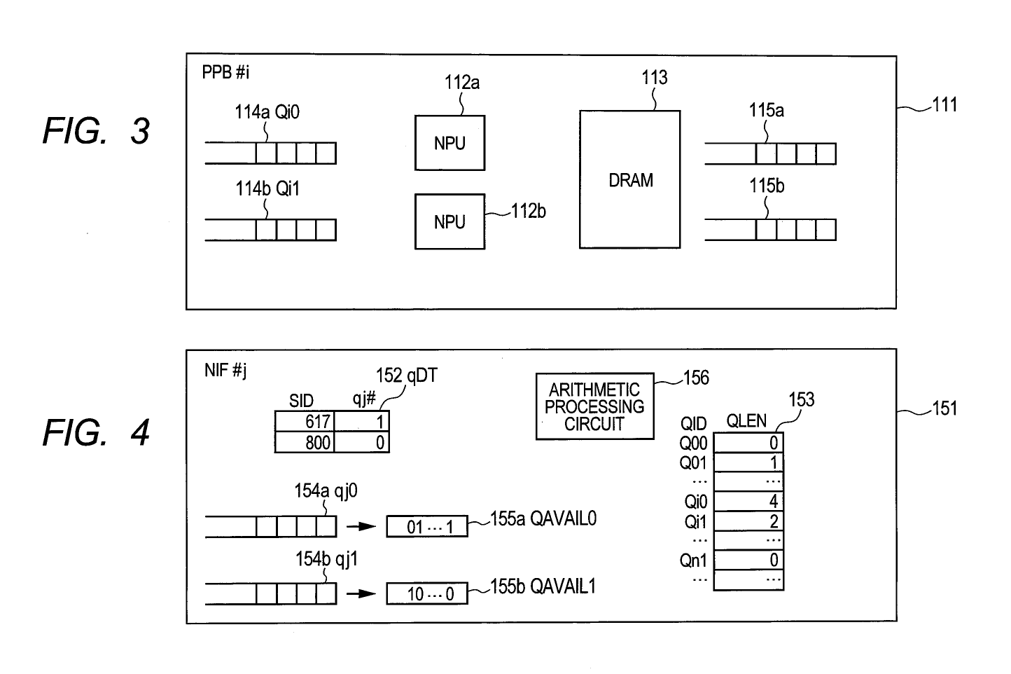

FIG. 3 shows a configuration of the packet processing board (PPB) 111 (111A, 111B, 111C). For example, the packet processing board 111 performs header processings, such as altering information of a protocol recorded in a header of the packet, as a packet processing. In this embodiment, the load table 145 of the control board 141 of FIG. 2 stores information of the load about each packet processing board 111, namely, an index value used as an index of the load. The load may be expressed in a queue unit, a packet processing board unit, a unit of the program that processes, etc. For example, the index value of the load may be expressed by the followings: the number of packets accumulated in input queues 114a, 114b as the queue unit; a data volume (the number of bytes or the number of packets) that flows into all the input queues or flows out of all the output queues as the packet processing board unit; and a CPU time (program execution time) of the packet processing board 111 as the unit of the program. Moreover, the index value of the load may be expressed by a value (especially, a monotonously increasing function value about these parameters) of a combination of these parameters (the number of packets, the data volume, and the CPU time). In this embodiment, the load table stores information of the loads of the input queues 114a, 114b that respective packet processing boards 111 have. Incidentally, the input queue that the packet processing board 111 has may be hereafter called a PPB queue.

In FIG. 3, the load QLEN of the PPB queue (input queue) of the packet processing board 111 is expressed by the number of packets (this may be a header or descriptor of the packet) accumulated in the PPB queue. The load (namely, the number of packets) of the PPB queue 114a is four, and the load (namely, the number of packets) of the PPB queue 114b is two. Incidentally, the load table 145 may store the loads in a unit of each packet processing board 111, as described above.

In FIG. 2 and FIG. 3, identifiers QIDs of the PPB queues of the i-th packet processing board 111 are shown by Qi0, Qi1, . . . , Qi(L−1) (L is the number of the PPB queues in the packet processing board 111). The load table 145 records the load of each PPB queue of each packet processing board 111 being associated with the identifier QID of the PPB queue. Incidentally, in the case where there exists only one PPB queue of the packet processing board 111, the identifier QID of the PPB queue also serves as an identifier of the packet processing board 111.

Contents of the load table 145 are updated by a scheduled or unscheduled notification from each packet processing board 111. Alternatively, the control board 141 may inquire the load periodically to each packet processing board 111 and may update the contents of the load table 145. That is, each packet processing board 111 autonomously, namely when an internal timer has operated for a fixed time or when a specific processing in the each packet processing board 111 starts or ends, observes the index value of the load of the each packet processing board 111 and transmits a packet containing the value to the control board 141. Alternatively, the control board 141 transmits a packet containing inquiry information to each packet processing board 111, and answering to it, the each packet processing board 111 observes the index value of the load and transmits a packet containing the value to the control board 141.

The program management table 146 stores a combination of an identifier SID that is a value contained in a specific field of the header of the packet, an identifier PID of the program for processing a packet having the SID, and information (queue list QAVAIL) of the PPB queue of the packet processing board 111 that is associated with the program. The identifier SID is an identifier showing the kind of packet, and is a service identifier that specifies a service that the packet should receive in this embodiment. In the program management table 146 of FIG. 2, a zero-th queue list is named QAVAIL0, a first queue list is named QAVAIL1, and a k-th queue list is named QAVAILk. The program management table 146 may store information of packet processing board 111 itself rather than information of the PPB queue of the packet processing board 111.

In this embodiment, although the SID is fixed in size and has a value, such as 617, 800, and 715, the SID may be variable in size. Moreover, in this embodiment, although the program management table 146 stores a value that should fully coincide with a value (identifier) contained in a field in the packet as the SID, a value that a part of this value is extracted and converted may be stored instead. When the extracted value is stored in the program management table 146, a value contained in the field in the packet is extracted and converted and then is compared with the identifier SID contained in the program management table 146. A relationship between the SID and the identifier PID of the program indicates which program should processes the packet containing an identifier corresponding to the SID: for example, the program is specified by a program load request from the network management device 12 in initialization of the packet stream processor 101 (the node apparatus).

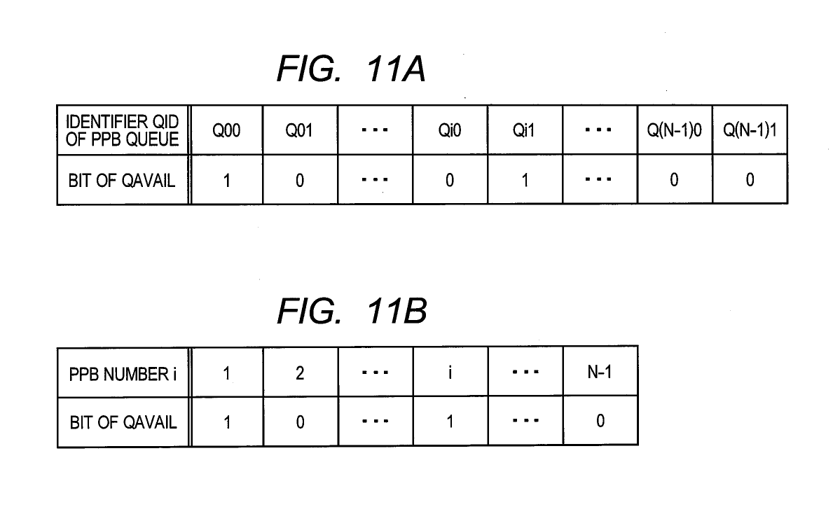

In the program management table 146, information of the PPB queue of a certain one of the programs P0, P1, . . . , Pm (the queue list QAVAIL) in the program management table 146 is a bit vector representing the PPB queue that leads to execution of the program, and represents the PPB queue that holds a packet that the program processes. Here, elements (bits) of the bit vector are associated with the identifiers QID (e.g., Q00, Q01, . . . , Qi0, Qi1, Q(N−1)0, Q (N−1)1) of the PPB queue in a predetermined order from the head. When a packet sent to the PPB queue with a certain identifier is processable by a program with an identifier PID, an element (a bit) corresponding to that certain identifier QID becomes unity in the bit vector (QAVAIL) to the identifier, and when it is not so, this element (the bit) becomes zero. For example, in the case where the program that has only the identifiers Q00 and the PPB queue of Qi1 hold the packet that a certain program should processes, bits of a bit vector QAVAIL to this program are associated with the PPB queue from the head (left) as shown in FIG. 11A. The control board 141 and the interface 151 may each store a table as shown in FIG. 11A in those pieces of memory. Moreover, the identifier QID of the PPB queue is not limited to what is described above: for example, the identifier by an integral value may be given sequentially through all the packet processing boards.

When loading the programs P0, P1, . . . , Pm into memory (the DRAM 113) of the packet processing board 111, the program loader 144 registers information (QAVAIL) of the PPB queue of the packet processing board 111 into the program management table 146.

The program storing unit 147 of the memory 143 stores the executable programs P0, P1, . . . , Pm. In this embodiment, although the programs P0, P1, . . . , Pm are stored in the memory 143, they may be stored in a mass storage, such as a semiconductor disk and a hard disk.

Referring to FIG. 3 again, the packet processing board 111 has the PPB queues (input queue's) 114a, 114b that include SRAM (static random access memory), NPUs 112a, 112b each capable of processing the inputted packet, and output queues 115a, 115b that include SRAM. Here, the NPU is a network processing unit, i.e., a kind of CPU, or a CPU core. A header and a descriptor (or a pointer) of a packet that was inputted into the packet processing board 111 via the switch fabric 181 are stored in the PPB queues 114a, 114b, and a body of the packet is stored in the DRAM (dynamic random access memory) 113. Incidentally, a configuration in which the entire packet is stored in the PPB queues 114a, 114b is also possible. Even when in operation, the packet processing board 111 can load and execute the program that a service needs.

The packets of the PPB queues 114a, 114b (in detail, the header and the descriptor of the packet) are forwarded to either of the NPUs 112a, 112b being in a state that can perform the packet processing (for example, an idle state) and are processed. The NPUs 112a, 112b execute a corresponding program stored in the DRAM 113 in order to process the packets of the PPB queues 114a, 114b, respectively. The packets of the PPB queues 114a, 114b may be sent to the NPUs 112a, 112b that are associated with the PPB queues in advance.

The packets after the processing (in detail, the header and the descriptor of the packet) are stored in the output queues 115a, 115b corresponding to the NPUs 112a, 112b, and are forwarded to the interface 151A, 151B, or 151C via the switch fabric 181.

FIG. 4 shows a configuration of the interface 151 (151A, 151B, and 151C). The interface 151 inputs therein a packet from the outside of the packet stream processor 101 (the node apparatus), outputs it to the packet processing board 111 via the switch fabric. Moreover, the interface 151 inputs therein a packet from the packet processing board 111 via the switch fabric, and outputs it to the outside of the packet stream processor 101.

The interface (NIF) 151 has an arithmetic processing circuit 156 for controlling the operation, such as ASIC, and one or more pieces of memory. The memory of the interface 151 stores a distribution table 152, input queues 154a, 154b, queue lists 155a, 155b, and a load table 153. Incidentally, hereafter, the input queues 154a, 154b of the interface 151 may be called an NIF queue. The queue lists 155a, 155b show information of the available packet processing boards 111.

The interface 151 searches the NIF queue corresponding to the identifier SID (namely, a classification of the packet) by referring to the distribution table 152, and distributes the packets to the NIF queues 154a and 154b for every identifier SID. Since the queue list makes the packets and the information of available packet processing board correspond to the packets for every pair of NIF queues 154a and 154b, the information of the available packet processing board 111 will be associated for every identifier SID or every distributed packet. Although the number K of NIF queues is two in this embodiment, the number K of NIF queues may be three or more. Moreover, it is also possible to eliminate the queue distribution table 152 by setting the number K of NIF queues to unity.

Furthermore, the interface 151 outputs the packet to resources of the packet processing board 111 based on the information of the packet processing board 111 that is associated for each distributed packet. As the resources of the packet processing board 111, there are the packet processing board 111 itself, and the PPB queue and the network processing unit NPU in the packet processing board 111. For example, the information of the packet processing board 111 includes the identifier (ID) and address of the PPB queue, the identifier (ID), the address, and a port number of the packet processing board itself, and a number of the network processing unit NPU.

The distribution table 152 shows a relationship between the identifier SID contained in the header of the inputted packet and the NIF queues 154a, 154b. The NIF queues 154a, 154b are held until the packet inputted into the interface 151 is forwarded to the packet processing board 111. The queue lists (or queue tables) 155a, 155b show queues that the packet can use. The queue lists 155a, 155b are association information each of which associates the packet with the information of the packet processing board 111 to which this packet is forwarded and where it can be processed by the program. Here, the information of the packet processing board 111 is information showing the PPB queue (input queue) that when the packet is forwarded to there, can process it with a corresponding program.

In this embodiment, the load table 153 stores the number of packets contained in each PPB queue etc. as the load of the packet processing board 111 after associating it with each PPB queue. The contents of the load table 153 are equal to the contents of the load table 145 of the control board 141. Moreover, the load table 153 is updated by a scheduled or unscheduled notification from the packet processing board 111 like the load table 145. The load may be notified to each interface 151 from each packet processing board 111 at fixed intervals, and the load shown in the load table 153 may be updated based on the notified load.

The PPB queue such that a load shown in the load table is low and corresponding bits of the available queue lists (the bit vector QAVAIL) 155a, 155b are set to unity (namely, available) is selected, and packets held in the NIF queues 154a, 154b are forwarded to the selected PPB queue. For example, if the bit vector of the available queue list corresponding to the NIF queue is (01 . . . 0), the packet of the NIF queue will be forwarded to the PPB queue of the identifier Q01.

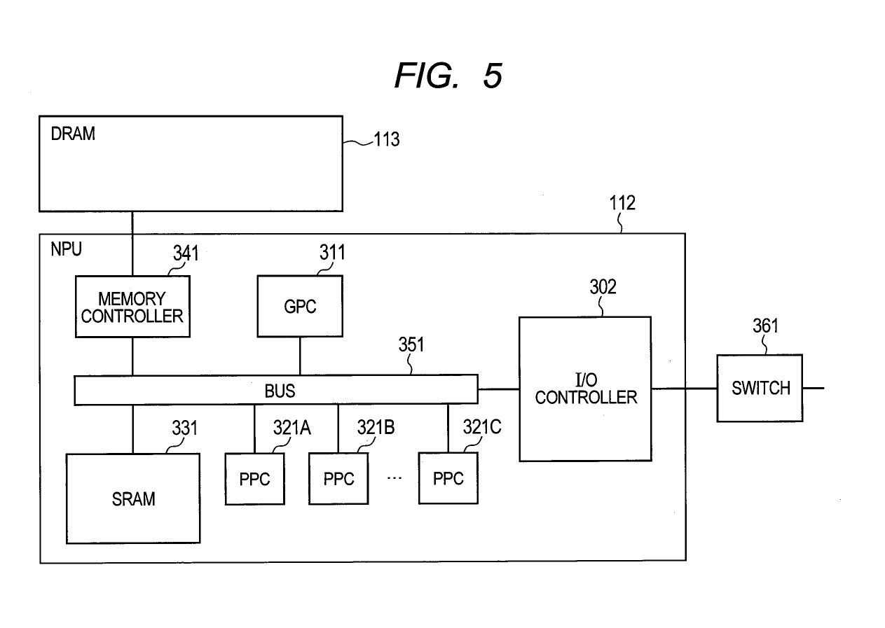

FIG. 5 shows a configuration of the network processing unit (NPU) 112. The network processing unit 112 (112a, 112b) has a single general purpose processing core (GPC) 311, multiple packet processing cores (PPCs) 321, an I/O controller 302, SRAM 331, and a memory controller 341, and a bus 351 for connecting these. The identifier by an integral value is given to each packet processing core 321. When giving an explanation common to all the packet processing cores 321A, 321B, and 321C, these are also generically named a packet processing core 321.

The general purpose processing core 311 mainly controls units in the network processing unit 112. The multiple packet processing cores 321 mainly execute data processings in parallel. The I/O controller 302 is connected to a switch 361 existing outside the network processing unit 112, i.e., on the packet processing board 111.

Although the SRAM 331 has a small capacity, it is a main storage with a small delay. Moreover, the memory controller 341 is connected to the DRAM 113 existing outside the network processing unit 112, i.e., on the packet processing board 111. Although the DRAM 113 has a large capacity, it is a main storage with a somewhat large delay.

The switch 361 forwards packet data that arrives at the packet processing board 111 via the switch fabric 181 to the I/O controller 302. The I/O controller 302 forwards the packet data to the SRAM 331 through the bus 351 and forwards it to the DRAM 113 via the memory controller 341. The packet data stored in the SRAM 331 or the DRAM 113 is processed in the packet processing core 321 to be stored again in the SRAM 331 or the DRAM 113, or is outputted to the outside of the network processing unit 112 through the I/O controller 302.

FIG. 6 shows a procedure of a program loading processing that the program loader 144 of the control board 141 performs through the CPU 142. When the load of one of the PPB queues exceeds a threshold in the load table 145 for performing load monitoring, the program loading processing is performed. Moreover, also when the control board 141 receives the program load request that the network management device 12 sent, the program loading processing is executed. The network management device 12 sends the program load request to the control board 141 as per instruction of an administrator or a management program for the initialization etc. before packet processing start of the packet stream processor 101.

However, when the program loader 144 receives the program load request, the program has not been stored in the program storing unit 147 yet. For this reason, in this case, the CPU 142 stores a program specified by the program load request or a program contained in the program load request in the program storing unit 147, and subsequently executes a procedure of FIG. 6. Incidentally, in the program load request, the program may be specified by a URL where it exists.

In the program loading processing, the program is loaded into the packet processing board 111. Furthermore, the association information (the queue list QAVAIL) that associates each packet with information of the packet processor unit capable of processing this is updated in each interface 151 so that the packet that the loaded program should process may be sent to the packet processing board 111. Thereby, the packet having arrived at the interface is forwarded to one of the packet handlers into each of which the program capable of processing it is loaded according to this association information at high speed, and is processed by the loaded program at high speed. Each packet handler 111 notifies the load to the program loader 144, and the program loader 144 having received the notification can load a program whose load is large into other packet handlers 111, before the load of the specific packet handler 111 becomes excessive.

Furthermore, when a program with a large processing load exists but an unused packet handler 111 does not exist, it is possible for the program loader 144 to select a program that has been distributed to multiple packet handlers 111 but whose processing load is low. The program loader 144 can delete the contents of the distribution table 152 related to a service (the service identifier SID) of a program whose processing load is low, can unload the program from one of the multiple packet handlers 111, and can load a program whose processing load is high instead.

When the program loading processing is started, first, at Step S411, the program loader 144 selects the packet processing board 111 not used or in low load that can perform the packet processing and either of the PPB queues 114a, 114b in this board by referring to the load table 145. Incidentally, when the processing of Step S611 of a below-mentioned load monitoring processing has been executed, the PPB queues 114a, 114b in low load selected at Step S611 and the packet processing board 111 containing it may be selected in Step S411. For example, the packet processing board 111 having a minimum load of the load table 145 may be determined to be in low load.

The program loader 144 registers the selected PPB queue in the program management table 146. The selected PPB queue is shown in the list of the PPB queues (i.e., the bit vector QAVAIL), that is, a bit corresponding to the selected PPB queue is set to unity. Incidentally, when an item about the identifier SID (the service identifier etc.) of the packet that the program to be loaded should process does not exist in the program management table 146, the item is generated, and the identifier PID (a pointer or a URL to the program storing unit 147) of the program and the selected PPB queue are registered. Moreover, when an item about the identifier SID of the packet that the program to be loaded should process exists in the program management table 146, the selected PPB queue is added to the list of the PPB queues of the packet processing board 111, that is, a bit corresponding to the selected PPB queue is set to unity.

Next, at Step S412, the program loader 144 loads the program into the memory (the DRAM 113) of the selected packet processing board 111 and activates it.

Furthermore, at Step S413, the program loader 144 associates the identifier SID contained in the program load request with the NIF queue in each interface 151. For this reason, the program loader 144 issues an instruction to each interface 151, and registers a pair of the identifier SID and the NIF queue number assigned to this in the distribution table (qDT) 152. For example, in FIG. 4, the NIF queue (qj1) of number 1 is assigned to SID 617 and the NIF queue (qj0) of number 0 is assigned to SID 800 in the j-th interface NIF#j. Incidentally, in the program loading processing executed when the load of the PPB queue exceeds the threshold, since the distribution table (qDT) 152 is already set up at the time of the program load request, Step S413 may be omitted.

Finally, at Step S414, in response to the instruction of the program loader 144, each interface 151 registers all the PPB queues selected at Step S411 in the list QAVAIL of the PPB queues by setting bits corresponding to them to unities.

The contents of the list QAVAIL of the PPB queues memorized in the memory of the interface 151 become equal to the list QAVAIL of the PPB queues memorized in the memory of the control board 141. Thereby, when there does not exist the PPB queue registered in the list of the PPB queues before execution of the program loading processing (when all the bits of the bit vector QAVAIL are zeros), the packet having arrived at the interface 151 can be newly processed by the program on the packet processing board 111. Moreover, when an already registered PPB queue exists in the list QAVAIL of the PPB queues (when one of bits of the bit vector QAVAIL is unity), the packet having arrived at the interface 151 is forwarded not only to the already registered PPB queue but also to a newly registered PPB queue, and the load of the packet processing board 111 can be distributed.

The list (QAVAIL) of the PPB queues will also exist in each interface 151 in addition to the control board 141, and thereby the packet will be able to be processed in each interface 151 at high speed. In the interface 151, the list (QAVAIL) of the PPB queues is stored in memory capable of being accessed at high speed, such as CAM (content addressable memory), so that the packet can be processed at wire rate.

Next, the program load request for activating the program loading processing in the packet stream processor 101 will be explained. The network management device 12 sends the program load request to the control board 141 of the packet stream processor 101 as per instruction of the administrator or the management program for the initialization etc. before the packet processing start of the packet stream processor 101. The program load instruction includes the following items (i) to (iii): (i) URL of a program or the program itself, (ii) service identifier (SID), and (iii) load forecast information (resource information).

Regarding the item (i), when the program load request includes the program itself, the control board 141 stores the program, as it is, in the program storing unit 147. When a URL of the program is contained in the program load request, the control board 141 accesses a specified URL by HTTP (HyperText Transfer Protocol), receives the program, and stores it in the program storing unit 147, or stores the URL itself in the program storing unit 147. The program is an object program or a source program. In the case of the source program, the control board 141 includes a compiler for converting the source program into an object program, and stores the object program obtained by the compilation in the program storing unit 147. Instead, the control board 141 may compile the source program as a part of the program loading processing. In doing compilation, the compiler of the language is used according to a language with which the source program was described. For example, if a fact that the source program is for a specific architecture (for example, a CPU of a specific network processor) is described in the source program, the compiler for the network processor will be used.

Incidentally, the program loader 144 having received the program load request containing neither the program nor its URL can assume that when an element containing the service identifier specified in the program load request exists in the program management table 146, the program containing the element is specified in the program load request.

Regarding the item (ii), the service identifier (SID) is a value that the packet contains in order to specify a program that processes itself. The service identifier corresponds to a program, in a one-to-one manner, or in a many-to-one manner.

Regarding the item (iii), the load forecast information is information to forecast a load that the program gives the packet stream processor 101 (the node apparatus). The load forecast information includes a resource amount required to execute the program one time or information for estimating it as first information, and the number of times of execution of the program or information for estimating it as second information. The resource amount expressed with a processing time, a memory quantity, etc. as the first information may be given by a value or a function according to an attribute of the packet that should be received. Incidentally, the resource amount required to execute the program one time can also be estimated by a static analysis or dynamic analysis of the program by executing the program with standard input data given. In that case, the first information is unnecessary. The number of times of execution of the program as the second information is given in a form of the number of packets, but may be given in a form of a bandwidth (a bit rate). If the bandwidth is specified, the number of packets can be estimated using an estimate of average packet length.

When the program loader 144 in the control board 141 receives the program load request, a specified program to the packet having the specified service identifier is loaded into the selected packet processing board 111 and is executed (S412). The packet generated or forwarded by the specified program can initialize the packet stream processor 101 so that its destination (for example, one of adjacent node apparatuses) may be decided by the program. However, the packet stream processor 101 can be configured to function as a normal Ethernet (a registered trademark, the same shall apply hereafter) or an IP router and to be initialized so that the packet may be forwarded automatically. Moreover, the packet stream processor 101 can also be initialized so as to discard all packets that have arrived at it as its initial state.

Moreover, when the service identifier of the packet having arrived does not exist in the queue distribution table 152, the NIF 151 can also transmit the program load request to the program loader 144. In this case, it is also possible to transmit the program load request containing neither a program nor its URL. Such a program load request is equivalent to a request of inquiring a server of a switch operation when a new flow arrives at an OpenFlow switch. (Here, OpenFlow is a network control technology that the OpenFlow Switching Consortium is advocating.) That is, in the OpenFlow switch, although its operation is selected from a range decided in advance, an operation of the packet stream processor 101 on a packet having the service identifier can be given by an arbitrary program in this embodiment. In this embodiment, although one field in the packet called the service identifier is used for selection of the program, values of the multiple fields in the packet can also be used as in the OpenFlow switch.

FIG. 7 shows a procedure of the program unloading processing that the program loader 144 of the control board 141 performs through the CPU 142. When the load of execution of the program exceeds the threshold in the load monitoring, the program unloading processing is executed in order to unload other programs from the packet processing board 111 into which this program is newly loaded. In the load table 145, when the load of the PPB queue corresponding to this program exceeds the threshold, it can be determined that the load of execution of this program has exceeded the threshold.

Moreover, when the control board 141 receives the program unloading request sent from the network management device as per instruction of the administrator or the management program, the program loader 144 executes the program unloading processing for all the packet processing boards 111 into each of which the program of an object of the unloading processing was loaded. After that, the program loader 144 deletes this program or a corresponding URL from the program storing unit 147. The program unloading request contains the service identifier. Since the service identifier corresponds to a program in a one-to-one manner or in a many-to-one manner, the program to be unloaded can be specified with it. After the program unloading processing is performed, the same processing as that before the program corresponding to this service was loaded is performed on the packet having the service identifier contained in the program unloading request.

Referring to FIG. 7, when the program unloading processing starts, first, at Step S511, the program loader 144 finds the packet processing board 111 in which the program to be unloaded exists and the PPB queue in the board that the program uses. Incidentally, when the load monitoring is being performed, this PPB queue is the PPB queue in low load being selected at S611 (FIG. 8) of the below-mentioned load monitoring processing. The program loader 144 deletes the PPB queue that is obtained from the list (the bit vector QAVAIL) of the PPB queues of the program management table 146 (namely, a bit associated with this PPB queue is set to zero).

Next, at Step S512, when the PPB queue that the program can use dose not exist in the program management table 146, the program loader 144 sends an instruction to every interface 151 to erase the NIF queue assigned to a service corresponding to this program (namely, the identifier SID of this service) in the distribution table qDT of each interface 151. When the list of the PPB queues that the program management table 146 contains becomes empty (that is, all the bits of QAVAIL are zeros), it is determined that the PPB queues used by the service does not exist.

Furthermore, at Step S513, all the PPB queues obtained at S511 are erased from the list (QAVAIL) in each interface 151 that the service uses. Thereby, it does not happen that when the PPB queue registered in the list (QAVAIL) no longer exists, a packet having arrived at the interface 151 is processed by a program on the packet processing board 111. That is, the packet having arrived at the interface 151 is discarded by the initialization, or is processed as a usual Ethernet packet or an IP packet. Moreover, when the PPB queue registered in the QAVAIL remains, an effect that the load is concentrated on the remaining PPB queue and consequently on the packet processing board 111 containing this PPB queue arises.

Finally, at Step S514, the program loader 144 stops and unloads the program on the packet processing board 111 obtained at S511. Moreover, if the program is unloaded from all the packet processing boards 111, this program is deleted also from the program table 146. The program loader 144 deletes the program from the memory (the DRAM 113) of this packet processing board 111. In the packet processing board 111 from which the program is unloaded, although it becomes impossible to execute the program, the memory that the program has occupied is released, an other program is loaded into this memory and uses it.

FIG. 8 shows a procedure of the load monitoring processing that the CPU 142 of the control board 141 performs repeatedly and periodically. In the load monitoring processing, the load table 153 is scanned and processings of Step S610 and thereafter are repeatedly executed on each element that represents a load in the load table 153.

At Step S610, it is determined whether the PPB queue qh corresponding to the selected element QLEN of the load table 153 is in high load. If the PPB queue qh is in high load, processings of Steps S611 to S613 will be executed. In this embodiment, the element QLEN indicating a load in the load table 153 is the number of packets accumulated in the corresponding PPB queue qh. When the load (here, the number of packets) exceeds a fixed threshold, it is determined that the PPB queue qh is in high load. For example, the threshold is a value of three as the number of packets. However, the threshold does not need to be a fixed value, and the threshold may be set larger as a value of an other element QLEN of the load table becomes higher.

At Step S611, the load table 153 is referred to, and the PPB queue ql un-assigned (unused) or in low load and the packet processing board PPBpl containing it are selected. The PPB queue ql un-assigned or in low load can be found by scanning the load table 153. However, it is also possible to obtain the PPB queue ql in the last scanning and to save this. Here, the PPB queue that has a minimum load in the load table 153 can be selected as the PPB queue ql in low load.

At Step S612, when the selected PPB queue ql has already been assigned (namely, being in low load), according to the unloading processing of FIG. 7, the PPBpl and the memory corresponding to the PPB queue ql are released. That is, the program that processes the packets accumulated in the PPB queue ql is deleted from the memory (the DRAM 113) of the packet processing board PPBpl.

At Step S613, the program that was processing the packet of the PPB queue qh in high load is loaded also into the memory (the DRAM 113) of the packet processing board PPBpl containing the PPB queue ql un-assigned or in low load according to the program loading processing of FIG. 6. Furthermore, in the available queue lists 155a, 155b (QAVAILs) to the packet sent to the PPB queue qh in high load, the PPB queue ql un-assigned or in low load is added. That is, the packet associated with the PPB queue qh in high load in the available queue lists 155a, 155b (QAVAILs) is forwarded to the packet processing board PPBpl un-assigned or in low load, and is processed by a program that is newly loaded into the packet processing board PPBpl.

At Step S614, it is determined whether the processing is completed for all the elements that show loads of the load table 153. When the processing is not completed for all the elements, the next element is selected at Step S615 and the routine returns to Step S610. When the processing is completed for all the elements, the routine is ended.

In the load monitoring processing of FIG. 8, the PPB queue and the program make a one-to-one correspondence. When the un-assigned PPB queue does not exist, unloading of the program is performed in the packet processing board PPBpl. However, there is a case where a single PPB queue is associated with multiple programs. In such a case, when assigning the PPB queue currently used to a new program, it is not necessarily required to unload the program. However, since an interference among services (program processings) occurs when a single PPB queue is shared by many programs, if the number of programs that are made to correspond to a single PPB queue exceeds a fixed number, the programs may be unloaded. Moreover, when the memory to be assigned to the program runs short or a margin is lost, the program may be unloaded.

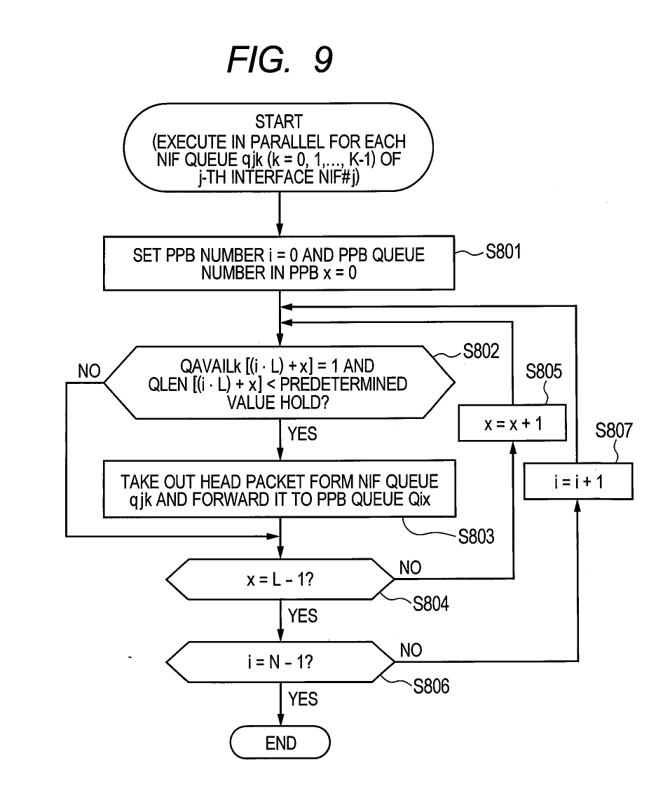

FIG. 9 shows a procedure of a packet forwarding processing (a PPB queue selecting processing) that the arithmetic processing circuit 156 of each interface 151 performs. In the packet forwarding processing, the packet processing board (PPB) 111 and the PPB queue in the packet processing board 111 are selected, and the packet in the interface 151 is forwarded to the selected PPB queue. A j-th interface 151 in which the packet forwarding processing is performed is denoted by NIF#j. The packet forwarding processing is performed in parallel on all the NIF queues (input queues) qjk (here, k=0, 1, . . . , K−1) in the interface NIF#j . That is, the packet forwarding processing is executed K times (in FIG. 4, K=2) in parallel for every interface 151.

At Step S801, first, a number i of the packet processing board (PPB) 111 is set to zero (i=0), and a number x of the input queue (PPB queue) in the packet processing board 111 is set to zero (x=0).

At Step S802, as the determination processing of forwardability, it is determined whether QAVAILk [(i·L)+x] is equal to unity and QLEN[(i·L)+x] is smaller than a specified value (e.g., 2). If QAVAILk[(i·L)+x]=1 and QLEN[(i·L)+x] is smaller than the specified value, the routine will proceed to Step S803; if it is not so, the routine will proceed to Step S804. Here, QAVAILk [ ] represents a [ ]-th bit from the highest bit in the bit vector QAVAILk that represents the PPB queue capable of processing a packet of a k-th NIF queue qjk. When the packet of the k-th NIF queue qjk is forwarded to the x-th PPB queue of the i-th packet processing board 111, if it is processable by the program, QAVAILk[(i·L)+x] will become unity, and if it is un-processable, QAVAILk[(i·L)+x] will become zero. Moreover, QLEN[ ] represents the [ ]-th element (load) from the highest element in the load table 153. QLEN[ ] is a value representing the load, and is the number of packets contained in the PPB queue here.

At Step S803, as the forwarding processing, a top packet is taken out from the NIF queue qjk, and is forwarded to the x-th PPB queue Qix in the i-th packet processing board 111.

At Step S804, it is determined whether the determination processing of forwardability at 5802 is completed for all the PPB queues in the i-th packet processing board 111. That is, denoting the number of the PPB queues in the packet processing board 111 by L, it is determined whether x=L−1 holds. When x does not satisfy x=L−1, the number x increments by one at S805, and a processing of S802 is performed on the next PPB queue. Thereby, determination processing of forwardability of S802 is performed on all the PPB queues (x=0, 1, . . . , L−1) in the i-th packet processing board 111. On the other hand, when x satisfies x=L−1, the routine proceeds to Step S806.

At Step S806, it is determined whether the determination processing of forwardability of S802 is completed for all the packet processing boards 111. That is, denoting the number of the packet processing boards 111 in the packet stream processor 101 by N, it is determined whether the number i is i=N−1. When does not satisfy i=N−1, the number i increments by one at S807, and the processing of S802 is performed about the next packet processing board. Thereby, the processing of S802 is performed about all the packet processing boards 111 (i=0, 1, . . . , N−1) in the packet stream processor 101. The routine is ended when i satisfies i=N−1.

Explaining a case where k=1, L=2, N=2, and QAVAIL1=(1001) as a simple example, since QAVAIL1[0]=1 holds, if QLEN[0]<specified value (e.g., 2) holds, a head packet of the NIF queue 154b (qj1) will be forwarded to the PPB queue Q00, and will be processed by a program (already loaded into PPB#0) corresponding to the identifier SID of the packet. Since QAVAIL1 [1]=0 and QAVAIL1 [2]=0, regardless of QLEN[1] and QLEN [2], the packet of the NIF queue 154b (qj1) is not forwarded to the PPB queues Q01 and Q10. Since QAVAIL1 [3]=1, if QLEN [3]<specified value holds, a next head packet of the NIF queue 154b (qj1) will be forwarded to a PPB queue Q11, where it will be processed by the program (having loaded into PPB#1) corresponding to the identifier SID of the packet.

In the packet forwarding processing, when the list QAVAIL of available PPB queues includes representations (i.e., unity) of the multiple PPB queues, the packets related to one service identifier SID need to be distributed to the PPB queues. By a round robin scheduling as described above, as a simplest method, the packet can be forwarded by using the PPB queue whose load is lower than a specified value sequentially. On the other hand, more packets can also be forwarded to the PPB queue (or packet processing board) in low load of the load table 153. For example, PPB queues can be weighted by using a function that decreases monotonously depending on a value of the load, and packets can also be forwarded to the PPB queues according to the weights.

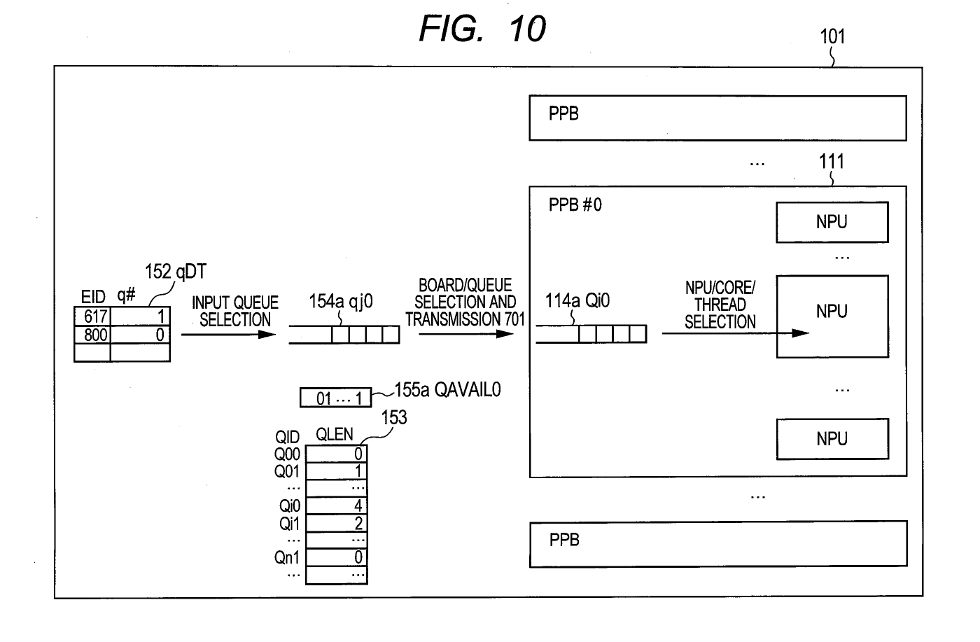

With reference to FIG. 10, the forwarding processing whereby the packet having arrived at the interface 151 is forwarded to the NPU of the packet processing board 111 will be further explained. First, the queue distribution table 152 (qDT) is used to the packet having arrived at the interface 151, and a number (or identifier) of the NIF queue into which the packet is inputted is selected from the identifier (SID) contained in the packet. If the NIF queue having the selected number is the NIF queue 154a, the packet will be registered in the NIF queue 154a. According to a procedure of FIG. 9, the packet is forwarded to the PPB queue in the packet processing board 111 from each NIF queue. Therefore, the packet in the NIF queue 154a is also forwarded. In FIG. 10, it is assumed that the destination is the PPB queue 114a of PPB#0. The packet is registered in the PPB queue 114a after the forwarding. In the packet processing board 111, the NPU that did not perform the processing or the NPU that completed the processing takes out one packet from the head of one of the PPB queues and processes it. Every NPU repeats this operation.

According to this embodiment, the interface (NIF) 151 connects to the multiple packet processor units 111 through the switch 181, stores the association information (e.g., the queue list QAVAIL) for associating each packet with information of the packet processor unit 111 capable of processing this, and forwards a packet that is associated with the information of the first packet processor unit in the association information to the first packet processor unit (e.g., PPB#0). When the first packet processor unit is determined to be in high load more than or equal to the threshold (S610), the control board 141 (control unit) updates the association information so that a packet being processable by the first packet processor unit is also associated with information of a second packet processor unit (e.g., PPB#1) in the association information (S414, S613). Then, the interface 151 forwards a packet that is associated with information of the second packet processor unit (PPB#1) in the updated association information to the second packet processor unit.

Thereby, it becomes possible even for the second packet processor unit to process a packet being processable by the first packet processor unit in response to increasing load of the first packet processor unit. Therefore, it is possible to dynamically increase/decrease the number of the packet processor units each for processing a packet about a certain service according to the load, which makes flexible load distribution possible. Moreover, since the interface 151 has the association information, packets are distributed to the packet processor units at high speed, which makes possible the high speed processing of the packets in the node apparatus.

The interface 151 has the association information (the queue list QAVAIL) for each identifier (SID) that should be contained in each packet. The interface 151 forwards a packet containing the first identifier to the first packet processor unit that is associated in the association information (e.g., QAVAIL0) about the first identifier. The control board 141 updates the association information (e.g., QAVAIL0) about the first identifier so that the packet containing the first identifier may also be associated with the information of the second packet processor unit. The interface 151 forwards the packet containing the first identifier to the second packet processor unit.

When the service is specified by an identifier, the identifier is contained in the packet and the packet having the identifier and the information of the packet processor unit are associated with each other in the association information for each identifier of the interface 151. Thereby, the load of the processing can be distributed to multiple packet processor units for each packet that should receive a specific service.

The first packet processor unit has a first program for processing the packet containing the first identifier. When the first packet processor unit is in high load, the control board 141 loads the first program into the second packet processor unit (S412, S613). The second packet processor unit processes the packet containing the first identifier with the first program. Thereby, when a certain packet processor unit is in high load, a program that is executed by the packet processor unit will come to be executed by an other packet processor unit, which will distribute the load given by execution of the program.

The control board 141 sets the second packet processor unit as the packet processor unit in low load (S411, S611). The control board 141 deletes a second program from the second packet processor unit when loading the first program into the second packet processor unit (S612). Thereby, the memory that the second program occupies is released in the second packet processor unit, and the first program can be loaded into the memory of the second packet processor unit. Incidentally, since the second packet processor unit is in low load, even if it becomes impossible for the second packet processor unit to process the packet, there will arise little bad influences. Furthermore, the control board 141 deletes the information of the second packet processor unit in the association information about the second identifier contained in the packet that the second program processes (S513). Thereby, the packet that the deleted second program should process will not be forwarded to the second packet processor unit.

The control board 141 stores the same association information as the association information that the interface 151 has. For this reason, the control board 141 can load a program required in order to process the packet to be sent to the packet processor unit into the packet processor unit based on the association information.

Each packet processor unit sends the information of the load to the interface 151, and the interface 151 has the load table 153 for storing the information of the load. Thereby, the interface 151 can find out the packet processor unit in low load at high speed from among the packet processor units each capable of the packet processing based on the association information (S802), and can forward the packet to this packet processor unit in low load. The information of the load may be the number of the packets accumulated in each queue of each packet processor unit. Thereby, the load can be grasped easily.

### First Modification

In the above-mentioned embodiment, allocation of the resources in the packet processing board 111 is decided in the program loader 144 and the interface 151. However, in the program loader 144 and the interface 151, the resources may be managed and controlled using the packet processing board 111 as a unit, and the resource allocation in the packet processing board 111 may be decided in the packet processing board 111. That is, the packet inputted into the packet processing board 111 is allocated to the PPB queue in the packet processing board 111 according to a rule decided in the packet processing board 111. Then, when the NPU becomes idol, the PPB queue is selected, the packet is taken out, and the program specified by the identifier of the packet is executed in the NPU according to a decided scheduling algorithm. In this case, the bit vector QAVAIL may be not the list of the PPB queue but the list of packet processing boards each capable of processing the packet. In this case, the bits of the bit vector QAVAIL may be associated with the numbers (the port numbers may be sufficient) and the identifier of the packet processing board 111 from the top (left), as shown in FIG. 11B.

### Second Modification

In the above-mentioned embodiment, the control board 141 performed the load monitoring in a centralized manner. However, it is also possible to perform the load monitoring in a distributed manner. That is, each packet processing board 111 performs the load monitoring, and when the load is high, the packet processing board 111 issues an instruction to all the interfaces 151 each transmitting a packet to the packet processing board 111 and stops transmissions of the respective packets to the packet processing board 111. For this reason, each packet processing board 111 holds the program management table 146 that only the control board had in the above-mentioned embodiment, and manages it in a distributed manner. Therefore, each packet processing board 111 manages only the program that it uses with the program control table.

### Third Modification

Incidentally, in the embodiment described above, the destination of the packet from the interface 151 was determined based on the load of the PPB queue as the load of the packet processing board 111. However, it is also possible to decide the destination considering also the load of the interface 151 that is the destination of the program, i.e., a state of congestion. That is, each interface 151 grasps the interface 151 of the destination for each program on the packet processing board 111 first at the time of the program load request. Therefore, the program load request may include the information of the interface 151 of the destination, and it may be found from the contents of the program. Each interface 151 keeps the information of the interface 151 of the destination thus obtained and the congestion information periodically reported from the interface 151 of the destination, and when the interface 151 of the destination is in congestion, it delays a packet being processed by the program from being transmitted to the PPB queue. By this, the discard of the output packet by congestion of the destination interface 151 can be decreased.

It is clear that the present invention is not limited to the above-mentioned embodiments and their modification, and various alterations can be made within a range of its technological idea.

What is claimed is:

1. A node apparatus that connects to a network, comprising:
a plurality of packet processor units;
an interface unit that connects to the packet processor units through a switch, stores association information for associating each packet with information of the packet processor unit capable of processing it, and forwards a packet that is associated with information of a first packet processor unit in the association information; and
a control unit for, when the first packet processor unit is determined to be in a load more than or equal to a threshold, updating the association information so that a packet being processable by the first packet processor unit may also be associated with information of a second packet processor unit in the association information,
wherein the interface unit forwards a packet that is associated with the information of the second packet processor unit in the updated association information to the second packet processor unit.

2. The node apparatus according to claim 1,
wherein the interface unit has the association information for every identifier that should be contained in every packet,
wherein the interface unit forwards a packet containing a first identifier to the first packet processor unit that is associated in the association information about the first identifier,
wherein the control unit updates the association information about the first identifier so that a packet containing the first identifier may also be associated with the information of the second packet processor unit, and
wherein the interface unit forwards the packet containing the first identifier to the second packet processor unit.

3. The node apparatus according to claim 2,
wherein the first packet processor unit has a first program for processing a packet containing the first identifier,
wherein when the first packet processor unit is in a load more than or equal to the threshold, the control unit loads the first program into the second packet processor unit, and
wherein the second packet processor unit processes the packet containing the first identifier with the first program.

4. The node apparatus according to claim 3,
wherein when the first program is loaded into the second packet processor unit, the control unit deletes a second program from the second packet processor unit, and deletes the information of the second packet processor unit in the association information about the second identifier contained in the packet that the second program processes.

5. The node apparatus according to claim 1,
wherein the control unit stores the same association information as the association information that the interface unit has.

6. The node apparatus according to claim 1,
wherein each packet processor unit sends its load information to the interface unit, and the interface unit has a load table for storing the load information.

7. The node apparatus according to claim 1,
wherein the load information is the number of packets that accumulate in each queue of each packet processor unit.

8. A system that comprises a node apparatus for connecting to a network, and a management device for instructing the node apparatus so that the node apparatus may store at least a first program,
wherein the node apparatus includes:
a plurality of packet processor units;
an interface unit that connects to the packet processor units through a switch, stores association information for associating each packet with information of the packet processor unit capable of processing this, and forwards a packet that is associated with information of a first packet processor unit in the association information to the first packet processor unit so that the packet may be processed by the first program; and
a control unit that when the first packet processor unit is determined to be in a load more than or equal to a threshold, updates the association information so that the packet being processable by the first packet processor unit may also be associated with information of a second packet processor unit in the association information,
wherein the control unit loads the first program into the second packet processor unit, and
wherein the interface unit forwards a packet that is associated with the information of the second packet processor unit in the updated association information to the second packet processor unit.

9. The node apparatus according to claim 8,
wherein the interface unit has the association information for every identifier that should be contained in each packet,
wherein the interface unit forwards a packet containing a first identifier to the first packet processor unit that is associated in the association information about the first identifier,
wherein the control unit updates the association information about the first identifier so that the packet containing the first identifier may also be associated with the information of the second packet processor unit, and
wherein the interface unit forwards the packet containing the first identifier to the second packet processor unit.

10. The system according to claim 9,
wherein when the first program is loaded into the second packet processor unit, the control unit deletes a second program from the second packet processor unit, and deletes the information of the second packet processor unit in association information about a second identifier contained in a packet that the second program processes.

11. The system according to claim 8,
wherein the control unit stores the same association information as the association information that the interface unit has.

12. The system according to claim 8,
wherein each packet processor unit sends information of its load to the interface unit, and the interface unit has a load table for storing the load information.

13. The system according to claim 12,
wherein the information of the load is the number of the packets accumulated in each queue of each packet processor unit.

14. A packet processing method that is executed in a node apparatus connecting to a network,
wherein the node apparatus has a plurality of packet processor units and an interface unit that connects to the packet processor units through a switch and stores association information for associating each packet with information of the packet processor unit capable of processing this,
wherein the packet processing method comprises:
forwarding a packet that is associated with information of a first packet processor unit in the association information to the first packet processor unit;
when the first packet processor unit is determined to be in a load more than or equal to a threshold, updating the association information so that a packet being processable by the first packet processor unit may also be associated with information of a second packet processor unit in the association information; and
forwarding the packet that is associated with the information of the second packet processor unit to the second packet processor unit.
